(19) United States
(12) Patent Application Publication
(10) Pub. No.: US 2024/0043186 A1
(43) Pub. Date: Feb. 8, 2024

(54) FILTER FOR A VENT OPENING OF A CONTAINER

(71) Applicant: QOS Group B.V., Maarssen (NL)

(72) Inventor: Elmar Oostveen, Nieuwersluis (NL)

(21) Appl. No.: 18/362,231

(22) Filed: Jul. 31, 2023

(30) Foreign Application Priority Data
Aug. 3, 2022 (NL) 2032673

(51) Int. Cl. B65D 51/16; B65D 43/02; B01D 46/00; B01D 46/10

(52) U.S. Cl. CPC B65D 51/16; B65D 43/0231; B01D 46/0001; B01D 46/10; B01D 46/0005

(57) ABSTRACT

A filter for a vent opening of a container comprises a housing and a filter element which are integrated by means of an injection molding process. A first part of the housing is formed by injection molding, after which a solid filter element and the first part of the housing are placed in a mold such that a circumferential edge portion of the solid filter element and the first part of the housing are adjacent to each other along a filling region. Material is injected against the solid filter element and the first part of the housing at the filling region, from which material a second part of the housing is formed after curing, hence forming the housing from the first and second parts of the housing and the filter element from the solid filter element. The filter element is rectangular.

### BACKGROUND

The discussion below is merely provided for general background information and is not intended to be used as an aid in determining the scope of the claimed subject matter.

The present invention relates to a filter for a vent opening of a container, comprising a housing and a filter element which are integrated by means of an injection molding process, in which a first part of the housing is formed by injection molding, after which a solid filter element and the first part of the housing are placed in a mold such that a circumferential edge portion of the solid filter element and the first part of the housing are adjacent to each other along a filling region and material is injected against the solid filter element and the first part of the housing at the filling region, from which material a second part of the housing is formed after curing, hence forming the housing from the first and second parts of the housing and the filter element from the solid filter element.

Such a filter is known and can be used as a vent opening in a bulk container, for example a big bag, for transporting and storing perishable bulk materials, such as food items including powder-shaped dairy products, rice, grain, flour, etc. Products in the food industry are often packaged in a protective atmosphere in order to extend preservability of products. For example, in case of packaging powder-shaped dairy products in a container the amount of oxygen in the container can be lowered by replacing it with nitrogen or a mixture of carbon dioxide and nitrogen. Air can be removed from the container by means of a vacuum technique after which the product can be flushed with an inert gas. The inert gas can be blown into the powder until the conditions in the container are atmospheric again. In order to remove air from the container without drawing out the stored product the container is provided with a filter that will be sealed after removing the air and introducing the inert gas through it.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An object is to provide a low-cost filter for a vent opening of a container.

This object is accomplished with the filter according to the invention, wherein the filter element is rectangular.

An advantage of the invention is that a large amount of filters can be manufactured at low cost since the rectangular shape of the filter elements results in minimal cutting losses. The solid filter element can be cut, for example by a knife, rather than being punched in case of a non-rectangular shape. For example, the solid filter element may be cut from a roll.

Manufacturing via injection molding provides a robust filter. The risk of detachment of the filter element is minimal. The injection molding process also provides the opportunity to apply a filter element which can be fixed to the first part of the housing by injection molding in which polyethylene, polypropylene, Nylon, Teflon, etc. is applied as material to be used for injection molding.

The filter element may be made from a sintered polymer.

The filter element and the first and second parts of the housing may be made from the same polymer, for example polyethylene. This has a positive effect on the adherence between the filter element and the first and second parts of the housing.

The filter element may be square.

Preferably, the housing is provided with a flange which surrounds the filter element, since this facilitates to attach the filter to a container.

The flange may have a substantially rectangular circumference. Preferably, the flange has rounded corners in order to avoid damage to a container to which the filter is attached.

In a particular embodiment the housing is provided with a front wall at a distance from the filter element, which front wall includes an opening that has a cross-sectional area which is smaller than a cross-sectional area of the filter element. This creates a narrowing flow area in a direction from the filter element to the opening.

In an embodiment ribs extend in radial direction of the opening and project from the front wall towards the filter element, which ribs support the filter element.

The ribs may extend from a circumferential edge of the opening or from a location at a distance from the opening.

Preferably, end portions of the ribs which are located next to the opening and face the filter element have rounded corners in order to avoid damage to the filter element when it tends to bend towards the opening, for example in case of connecting a vacuum system to the opening.

The filter may be provided with an elastic self-sealing septum at the opening which allows a needle to pass through it so as to take a sample between the septum and the filter element. A self-resealing septum provides easy access by a needle to the space between the septum and the filter element so that a sample may be collected therefrom without opening the container and removing the vacuum or inert gas therein.

The opening may be closed by a releasable cap.

The cap may be provided with a through-hole for passing a needle.

The septum may be provided in the cap.

The cap may be a screw cap.

The filter element may be flat.

The invention will hereafter be elucidated with reference to the schematic drawings showing embodiments of the invention by way of example.

### BRIEF DESCRIPTION OF THE DRAWINGS

FIG. 1 is a perspective exploded view of an embodiment of a filter for a vent opening of a container.

FIG. 2 is a perspective top view of the filter as shown in FIG. 1.

FIG. 3 is a similar view as FIG. 2, but showing an opposite side of the filter.

FIG. 4 is a cut-away view of the filter as shown in FIG. 3.

FIG. 5 is a perspective view of a part of FIG. 1 on a larger scale.

### DETAILED DESCRIPTION OF ILLUSTRATED EMBODIMENT

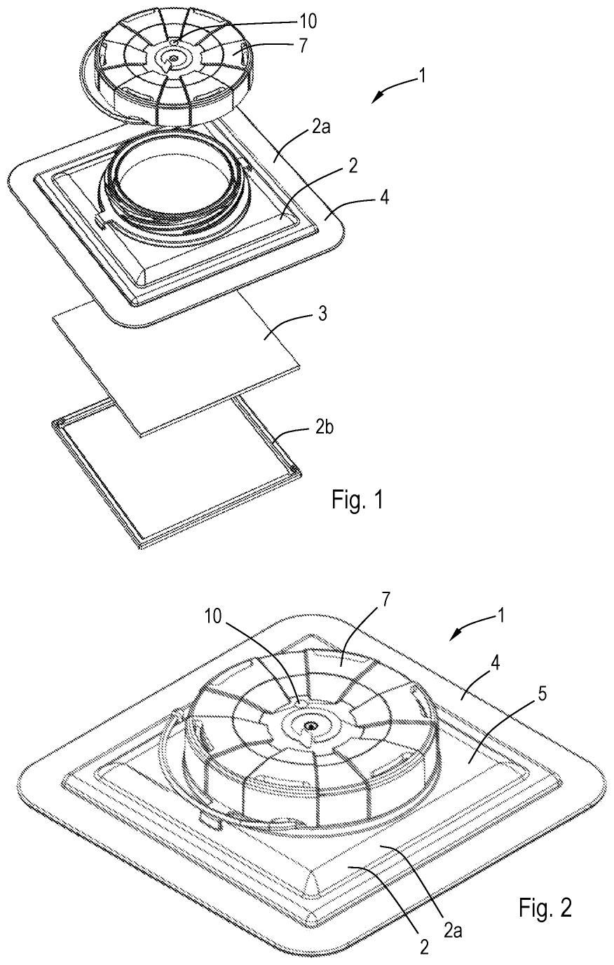

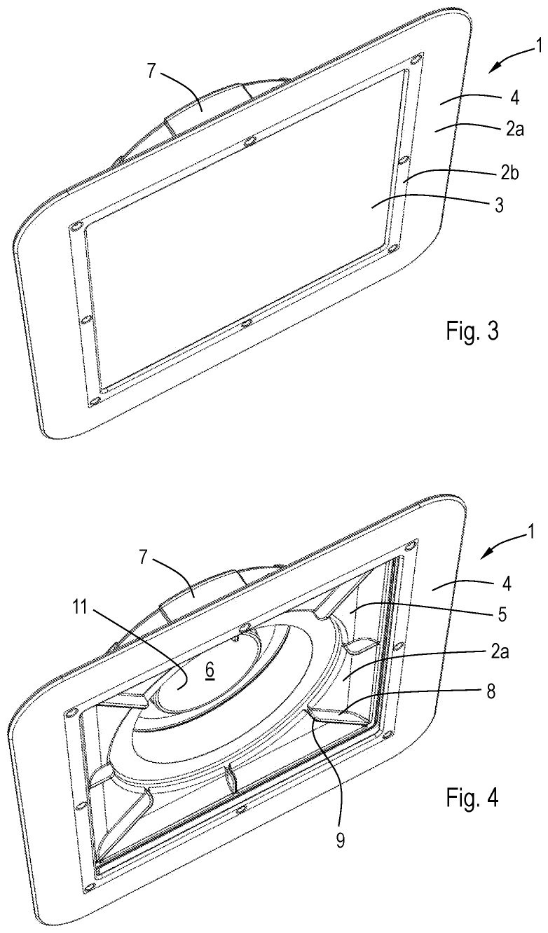

FIGS. 1-4 show different views of an embodiment of a filter 1. The filter 1 comprises a housing 2 and a filter element 3 which is fixed in the housing 2. The housing 2 has a flange 4 which surrounds the filter element 3, see FIG. 3. An upper part 2a of the housing 2 is made by means of a molding process and made from polyethylene. The filter element 3 is made from sintered polyethylene and placed, in the form of a pre-fabricated solid part, in an injection molding mold together with the at least partly cured upper part 2a, such that a circumferential edge portion of the solid filter element 3 and an inner rim of the flange 4 of the upper part 2a of the housing 2 are adjacent to each other along a filling region. Subsequently, liquid polyethylene for forming a lower part 2b of the housing 2 is introduced into the injection molding mold and injected against the filter element 3 and the upper part 2a of the housing 2 at the filling region so as to form the resulting filter 1. This means that in the resulting filter 1 the housing 2 and the filter element 3 are integrated by means of the injection molding process. In FIG. 1 the lower part 2b is shown as a separate frame.

The filter 1 can be mounted to a container (not shown), such as a big bag, for example by welding the flange 4 to a surrounding edge of an opening in the container. When the container is filled with a product having limited preservability, for example for the food industry, air can be removed from the container via the filter 1 whereas the product cannot be drawn out because of the presence of the filter element 3.

The filter element 3 is square and the flange 4 has a substantially square circumference, but rounded corners.

The housing 2 is provided with a front wall 5 which extends at a distance from the filter element 3 and partly parallel to the filter element 3. The front wall 5 includes a circular opening 6 that has a cross-sectional area which is smaller than a cross-sectional area of the filter element 3. The opening 6 is enveloped by a threaded tubular portion which projects from the front wall 5 and on which a screw cap 7 can be screwed.

FIG. 4 shows that the housing 2 is provided with ribs 8 which extend in radial direction of the opening 6 and project from the front wall 5 towards the filter element 3. The ribs 8 support the filter element 3. Spaces between the ribs 8 form flow areas between the filter element 3 and the opening 6. Each of the ribs 8 extends from a location at a distance from the opening 6. End portions of the ribs 8 which are located next to the opening 6 and face the filter element 3 have rounded corners 9 in order to avoid damage to the filter element 3 if a central portion thereof tends to bend towards the opening 6, for example in case of connecting a vacuum system to the opening 6.

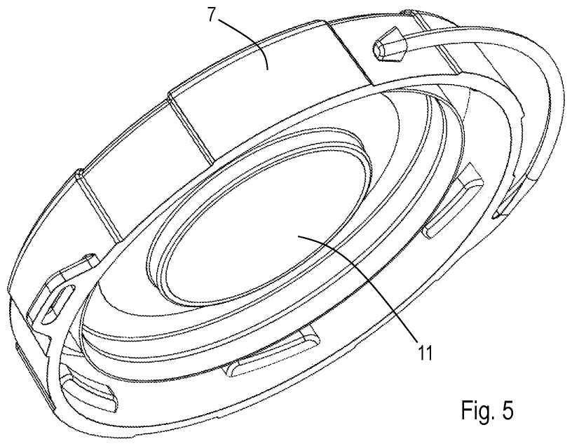

FIGS. 4 and 5 show that the screw cap 7 is provided with an elastic self-sealing septum 11 and FIGS. 1 and 2 show that the screw cap 7 is provided with a through-hole 10 for passing a needle through the screw cap 7 and the septum 11. When the filter 1 is mounted on a container to be vented, the container is sealed from the ambient air by the septum 11 after removal of the air and possible introduction of an inert gas into the container, whereas the septum 11 and the through-hole provide the opportunity to take a sample between the septum 11 and the filter element 3 trough inserting a needle.

The filter element 3 and the housing 2 may be made from the same basic material, which facilitates fusion of the edge portion of the filter element 3 and the lower part 2b of the housing 2 during the injection molding process.

The invention is not limited to the embodiment shown in the drawings and described hereinbefore, which may be varied in different manners within the scope of the claims and their technical equivalents.

What is claimed is:

1. A filter for a vent opening of a container, comprising a housing and a filter element which are integrated by an injection molding process, in which a first part of the housing is formed by injection molding, after which a solid filter element and the first part of the housing are placed in a mold such that a circumferential edge portion of the solid filter element and the first part of the housing are adjacent to each other along a filling region and material is injected against the solid filter element and the first part of the housing at the filling region, from which material a second part of the housing is formed after curing, hence forming the housing from the first and second parts of the housing and the filter element from the solid filter element, wherein the filter element is rectangular.

2. The filter according to claim 1, wherein the filter element is square.

3. The filter according to claim 1, wherein the housing is provided with a flange which surrounds the filter element.

4. The filter according to claim 3, wherein the flange has a substantially rectangular circumference.

5. The filter according to claim 3, wherein the flange has rounded corners.

6. The filter according to claim 1, wherein the housing is provided with a front wall at a distance from the filter element, which front wall includes an opening that has a cross-sectional area which is smaller than a cross-sectional area of the filter element.

7. The filter according to claim 6, wherein ribs extend in a radial direction of the opening and project from the front wall towards the filter element, which ribs support the filter element.

8. The filter according to claim 7, wherein the ribs extend from a circumferential edge of the opening.

9. The filter according to claim 7, wherein each rib extends from a location at a distance from the opening.

10. The filter according to claim 9, wherein end portions of the ribs which are located next to the opening and face the filter element have rounded corners.

11. The filter according to claim 6, wherein the filter is provided with an elastic self-sealing septum at the opening which allows a needle to pass through the elastic self-sealing septum so as to take a sample between the septum and the filter element.

12. The filter according to claim 6, wherein the opening is closed by a releasable cap.

13. The filter according to claim 12, wherein the cap is provided with a through-hole for passing a needle.

14. The filter according to claim 11, wherein the septum is provided in the cap.

15. The filter according to claim 12, wherein the cap is a screw cap.

16. The filter according to claim 1, wherein the filter element is flat.

17. A filter for a vent opening of a container, comprising:
a rectangular filter element;
a housing having a first part and second part, wherein a circumferential edge portion of the filter element on a first side is in contact with the first part and the second part is integrally joined to the first part about the circumferential edge portion of the first part and in contact with a second side of the filter element that is opposite the first side.

18. A method for making a filter for a vent opening of a container, comprising a housing and a filter element which are integrated by an injection molding process, the process comprising:
forming a first part of the housing by injection molding;
after forming the first part, placing a rectangular solid filter element and the first part of the housing in a mold such that a circumferential edge portion of the solid filter element and the first part of the housing are adjacent to each other along a filling region; and
injecting material against the solid filter element and the first part of the housing at the filling region from which material a second part of the housing is formed after curing, hence forming the housing from the first and second parts of the housing and the filter element from the solid filter element.
